(19) United States
(12) Patent Application Publication
(10) Pub. No.: US 2003/0026910 A1
(43) Pub. Date: Feb. 6, 2003

(54) Multiple layered waterproofing coating

(76) Inventor: Michael R. Wait, Newark, OH (US)

Correspondence Address: Susan J Wharton, Shook Hardy & Bacon LLP, One Kansas City Place, 1200 Main Strret, Kansas City, MO, 64105-2118, US

(21) Appl. No.: 09/819,034

(22) Filed: Feb. 16, 2001

Related U.S. Application Data
(62) Division of application No. 08/946,769, filed on Oct. 8, 1997, now abandoned.

(51) Int. Cl. B05D 1/36; B05D 1/02; B32B 7/02; B05D 7/00

(52) U.S. Cl. 427/402; 427/421; 428/212

(57) ABSTRACT

A multiple layered waterproofing coating comprising a first, flexible layer having relatively high flexibility, adhesiveness and elongation properties, which is adapted to bridge cracks even in low temperatures, and a second, protective hard layer having high tensile strength and low adhesiveness properties. The layers are prepared from liquid formulations which are spray applied to the surface to be coated, primarily in below-grade foundations. The first, flexible layer is formed by spraying onto a surface a liquid formulation which provides a dried coating layer having high flexibility, adhesiveness and elongation properties. A second, protective layer is formed over the first, flexible layer by spraying over the first layer a liquid formulation which provides, when dried, a hard coating layer having high tensile strength and modulus, and low adhesiveness properties.

### BACKGROUND OF THE INVENTION

This invention relates in general to waterproofing, and, more particularly, to liquid applied waterproofing coatings.

Waterproofing coatings are often applied to below-grade surfaces, such as concrete foundations and the like. These coatings can be applied in a number of methods, including the use of sheet waterproofing products. These products, however, have the disadvantage that the sheets are often large and cumbersome. In addition, seams are formed by the use of such sheets, and the seams must be further sealed to achieve the appropriate waterproofing specifications of a particular application.

Another method of applying waterproofing coatings is by spraying, troweling, mopping or painting a coating onto a surface. In the past, a single formulation has conventionally been applied to the below-grade surface in either one or several coats. These coatings must be formulated to be tough enough to withstand the physical pressures created during backfill and other construction trade stresses which are often applied to the coated surface. In addition, these coatings must also be flexible enough to bridge cracks, often found in the surface, at low temperatures. In known waterproofing coatings, one product has, unfortunately, been unable to achieve both characteristics. Coatings which are flexible enough to bridge cracks, withstand low temperatures and adhere well to concrete, cement blocks, other masonry substrates or other surfaces, typically have low strength characteristics. Similarly, coatings which have high modulus and high strength characteristics typically have low flexibility and low adhesion properties, creating problems in bridging cracks and adhering to the surface to be coated. It is thus often necessary to utilize a coating which is much stronger than needed for waterproofing purposes in a specific application, or the manufacturer of the waterproofing coating requires a protection board to be placed over the coated surface to add strength to and protect the coating from damage which often occurs during backfill and the like. Further, when coatings are utilized which have high adhesion properties, a problem occurs during backfill, as the backfill tends to adhere to the tacky outer surface of the coating, dragging it off of the coated surface as the backfill settles.

Some known waterproofing systems include an outer protective layer which incorporates gravel or sand therein, such as on steps or other surfaces where traction is needed. However, such layers are only able to be applied to horizontal surfaces, not to vertical, below-grade surfaces.

There is a need, therefore, to provide a below-grade waterproofing product and method which has both the flexibility needed to adequately seal and protect the surface, and also the strength to withstand the abrasion and other damages associated with backfill and other construction stresses. Further, there is a need to provide a below-grade waterproofing product and method which can be applied to both vertical and horizontal surfaces.

### SUMMARY OF THE INVENTION

The present invention is directed to a multiple layered liquid applied waterproofing coating. The invention overcomes the problems and limitations set forth above by providing a waterproofing system which achieves both the flexibility and adhesion needed to bridge cracks at low temperatures and adhere to concrete, cement blocks, other masonry substrates or other surfaces, and the strength needed to be resistant to damage which can occur during backfill and other stresses.

Accordingly, it is an object of the present invention to provide a multiple layered liquid applied waterproofing coating, and method for applying the same, which has the flexibility to bridge cracks even at low temperatures.

It is a further object of the present invention to provide a multiple layered liquid applied waterproofing coating, and method for applying the same, which has the strength to resist damage and withstand the stresses caused by backfill and other construction hazards.

It is yet another object of the present invention to provide a multiple layered liquid applied waterproofing coating, and method for applying the same, which has a low tack outer surface to prevent the backfill from grabbing onto the coating and dragging it off of the coated surface as the backfill settles.

It is still a further object of the present invention to provide a multiple layered liquid applied waterproofing coating, and method for applying the same, which has good adhesion characteristics so that it can adhere well to the surface to be coated.

It is an additional object of the present invention to provide a multiple layered liquid applied waterproofing coating, and method for applying the same, which presents a monolithic membrane coating without seams or other joints.

It is yet an additional object of the present invention to provide a multiple layered liquid applied waterproofing coating, and method for applying the same, which can be applied in liquid form to below-grade surfaces, including vertical surfaces.

These and other related objects of the present invention will become readily apparent upon further review of the specification. To accomplish the objects of the present invention, a multiple layered liquid applied waterproofing coating is provided comprising a first coating layer which is formulated to have good flexibility and good low temperature flexibility, which adheres well to concrete, and which has a low tensile modulus and low tensile strength; and a second coating layer adapted to be applied over the first coating layer, the second layer formulated to be a relatively hard, puncture-resistant surface, and to have a high modulus and high tensile strength, and low tackiness or adhesion properties.

In addition, a method for forming a waterproofing coating on a surface is provided, comprising preparing a first liquid coating formulation, the first coating formulation adapted to form a coating layer having good flexibility and good low temperature flexibility, and good adhesiveness; applying the first liquid formulation onto a surface to be coated to form a first, flexible coating layer preparing a second liquid coating formulation, the second coating formulation adapted to form a coating layer which has a relatively hard, puncture-resistant surface, and a relatively high modulus and high tensile strength, and low adhesiveness; applying the second liquid formulation over the first coating to form a second, hard coating layer; and allowing the coating layers to dry to form a waterproofing coating.

### DETAILED DESCRIPTION OF THE PREFERRED EMBODIMENT

The present invention comprises a multiple layered liquid applied waterproofing coating applied to below-grade surfaces, such as concrete foundations and the like. The coating of the present invention comprises a first layer which has good flexibility, good low temperature flexibility, adheres well to concrete, has high elongation properties, and has a low tensile modulus and low tensile strength. This flexible layer can be comprised of a number of different components, or can be a single component, as long as the flexibility and adhesiveness characteristics are achieved. In addition to these characteristics, this flexible layer must have good elongation and good crack bridging ability. A second layer is provided as a strong, protective layer which has a high modulus and high tensile strength, and low tackiness or adhesion properties. This layer should be hard and resistant to the abrasive forces associated with backfill, puncture and other similar abrasive forces often associated with construction. In addition, the second, protective layer can optionally include a pigment component to allow its application to be easily visible to the installer, and may also optionally include a UV protecting component. As will be seen below, and as will be apparent to those skilled in the art, the same or different ingredients can be used to form one or both of these layers, as the properties of some of the ingredients can be varied to achieve whichever of the above-noted characteristics are desired.

In one embodiment, one or both of the first and second layers comprise a polymer and asphalt system. Such a polymer asphalt system can use as the carrier either an organic solvent or a water emulsion system. The organic solvents can include, without limitation, aromatic, aliphatic, halogenated, oxygenated and cyclic aliphatic solvents, or combinations of two or more of the above solvents. Those skilled in the art can appreciate that asphalt polymer systems can be formulated to achieve the desired characteristics of either the first layer, namely good flexibility, adhesion and elongation properties, or the second layer, namely high tensile strength and modulus, and low adhesion properties.

In another embodiment, one or both of the layers comprise a polymer system, copolymer or polymer blend. These polymer systems can incorporate mineral and organic fillers, such as resins and organic fibers, or even asphalt, to achieve either specific desirable properties or less expensive systems. As noted above with the asphalt polymer systems, in the same manner that polymer properties can be changed, so can the properties of the systems which are formed from them. Indeed, the same polymers can be formulated to have different properties, and it is thus possible for such polymers, copolymers or polymer blends to ultimately be utilized for both the flexible first layer and the protective second layer, as will be discussed below in more detail. The polymer system of a preferred embodiment which can be formulated to achieve the desired characteristics of either the first layer or the second layer, or both layers, includes a formulation comprising acrylic polymers or urethane, with the ultimate properties of the urethane being achieved by selecting the appropriate polyol and diisocyanate prepolymers to make a hard, tough protective coating layer or a soft, flexible coating layer. Again, depending on the monomers or pre-polymers selected, polysulfide, epoxies and polyesters can also be useful to provide polymers having the desired characteristics of either of these two coatings. Some examples of such systems are set forth below. Indeed, as will be understood by those skilled in the art, polymer properties can be changed to achieve a variety of systems ranging from flexible systems with good elongation to hard, tough films with high tensile strength and modulus, in some instances by post-reacting the polymers by halogenation, epoxidation sulfonation, chlorosulfonation, or hydrolysis.

Some of the polymer systems which are useful in accordance with the teachings of this invention include, but are not limited to, polyvinyl acetate, polynitrile, polyvinyl pyridine, linear polyethylene, polypropylene, poly-1-butene, poly-1-pentene, poly-3-methyl-1-butene, poly-4-methyl-1-pentene, poly-4-methyl-1-hexene, poly-5-methyl-1-hexene, polyisoprenes, polybutadiene, polyisobutylene, polyvinyl cyclohexane, polymethylstyrenes, polydimethylstyrenes, polyfluorostyrenes, poly-2-methyl-4-fluorostyrene, polyvinylnaphthalene, polyxylene, polyoxymethylene, polyethylene oxide, polypropylene oxide, polyvinyl ethyl ether, polyvinyl propyl ether, polyvinyl isopropyl ether, polyvinyl butyl ethers, polyvinyl isobutyl ether, polyvinyl benzyl ether, polyisopropyl acrylate, polytertiary butyl acrylate, polymethyl methacrylates, polyethylene terephthalate, polytrimethylene terephthalate, polytetramethylene terephthalate, polypentamethylene terephthalate, polyhexamethylene terephthalate, polyoctamethylene terephthalate, polynonamethylene terephthalate, polydecamethylene terephthalate, polyethylene isophthalate, polytrimethylene isophthalate, polytetramethylene isophthalate, polyhexamethylene isophthalate, polyethylene sebacate, polytetramethylene sebacate, polydecamethylene sebacate, polyethylene adipate, polytrimethylene adipate, polydecamethylene adipate, polytrimethylene succinate, polycaproamide, nylon, polyhexamethylene adipamide, polyhexamethylene sebacamide, polydimethylsiloxane, polydecamethylene sebacamide, cellulose triacetate, cellulose tripropionate, cellulose tributyrate, polyvinyl chloride, polyvinylidene chloride, polychloroprene, polyvinyl fluoride, polychlorotrifluoroethylene, polytetrafluoroethylene, polyacrylonitrile, and polycarbonate. The above polymers may be useful in the form of grafted polymers, blends and copolymers.

Of course, as stated above, it is understood that the first, flexible layer can be formulated from one polymer system, copolymer or polymer blend, and the second, protective layer can be formulated from the same or different polymer systems, copolymers or polymer blends.

One general formulation of the multiple layered waterproofing coating of a preferred embodiment of the present invention is as follows:

| | |
|---|---|
| Ingredients | Range of Weight % |

Flexible first coating

| | |
|---|---|
| Asphalt emulsion | 50-94 |
| Polymer | 6-40 |
| Organic Solvent | 0-10 |
| Viscosity Modifier | 0.1-1 |

Protective second coating

| | |
|---|---|
| Asphalt emulsion with low | 10-95 |
| penetration value | |
| Polymer blend | 3-90 |
| Organic Solvent | 0-6.5 |
| Pigment | 2-15 |
| Viscosity Modifier | 0.1-6 |

According to the present invention and as discussed above, the desired properties of the flexible layer include high flexibility and high elongation characteristics, with the protective layer having lower relative flexibility and elongation. Specifically, the desired flexible layer made in accordance with this invention preferably will have an elongation percentage ranging from about 200% to about 3000%. The elongation for the protective layer preferably ranges from about 1% to about 300%. In a preferred embodiment, the elongation ranges for the protective layer should be less than 100%. In a preferred embodiment, the elongation for the flexible layer should be greater than that for the hard, protective layer.

As set forth above, the desired properties of the protective second layer made in accordance with the present invention include higher tensile strength or hardness, and higher tensile modulus than the flexible first layer. The tensile modulus of a material is the slope of the elongation versus tensile strength of a material. Generally, as harder materials are elongated, they reach their tensile strength much faster than flexible soft materials. Thus, the tensile modulus of the protective layer will be relatively higher than that of the flexible layer. The preferred ranges of tensile modulus for the flexible layer are from 10 to 1000 psi, with the more preferred range being from 10 to 500 psi. The preferred ranges of tensile modulus for the protective layer are from 500 to 1,450,000 psi, with the more preferred range being from 2000 to 145,000 psi. In a preferred embodiment, the tensile modulus of the protective layer is 15 to 25 times the tensile modulus of the flexible layer.

Similarly, the tensile strength of the protective second layer should be higher than the tensile strength of the flexible layer. The preferred ranges of tensile strength of the flexible layer, measured in psi, range from about 10 psi to about 1500 psi. In a more preferred embodiment, the tensile strength of the flexible layer ranges from about 50 psi to about 500 psi. The preferred ranges of tensile strength of the protective layer range from about 250 psi to about 12,000 psi. In a more preferred embodiment, the tensile strength of the protective layer ranges from about 200 psi to about 4000 psi. In a preferred embodiment, the tensile strength of the protective layer is approximately 2 to 4 times the tensile strength of the flexible layer. In a more preferred embodiment, the tensile strength of the protective layer is approximately 3 times the tensile strength of the flexible layer.

An additional measure of hardness is the Shore A test, conducted in accordance with ASTM E448. As with the tensile strength measurements, the Shore A hardness of the protective second layer should exceed that of the flexible first layer. In a preferred embodiment, the Shore A hardness of the protective layer is from 1 to 50 times the Shore A hardness of the flexible layer. In a more preferred embodiment, the Shore A hardness of the protective layer is 2 to 10 times that of the flexible layer. As the protective layer should be hard in order to function appropriately in accordance with this invention, it is preferred that the Shore A hardness of the second layer be greater than 40. In a preferred embodiment, the Shore A hardness of the second layer is 50 or greater.

A further measure of the properties of the two layers is the glass transition temperature, or the temperature at which a polymeric material changes from being flexible to being brittle like a thin piece of glass. The glass transition temperature of the flexible first layer is preferably at least 30° F. or below, and more preferably is 10° F. or below. The glass transition temperature of the protective second layer can be any value, although due to economic factors, the glass transition temperature will generally be 30° F. or above.

The following is a specific example of a preferred embodiment of the present formulation.

### EXAMPLE 1

| | |
|---|---|
| Ingredients | Weight by % |

Flexible Coating

| | |
|---|---|
| AC-20 asphalt emulsion, rapid set, made | 79 |
| with crude tall oil surfactant | |
| Styrene Butadiene Rubber Latex | 14.1 |
| Organic Solvent | 6.5 |
| Viscosity Modifier | .4 |

Protective Coating

| | |
|---|---|
| 0 penetration value Asphalt emulsion | 56.9 |
| Styrene Butadiene Rubber Latex, rubber | 21.6 |
| consisting of 29% styrene | |
| Styrene Butadiene Polymer Latex, polymer | 7.2 |
| consisting of 50-90% styrene | |
| Organic Solvent | 2.8 |
| TiO₂ Suspension | 8.9 |
| Viscosity Modifier | 2.6 |

In the above formulation for the flexible first layer, the AC-20 emulsion is an asphalt emulsion of a relatively high penetration value asphalt. The styrene butadiene rubber latex is a relatively flexible copolymer which provides flexibility to the formulation. As an alternative to this polymer rubber, natural rubber latex can be used. The organic solvent can comprise toluene, xylene, hexane, mineral spirits, aromatic solvents, aliphatic solvents, and mixtures thereof.

In the formulation for the protective second layer, in addition to the ingredients discussed above, the asphalt emulsion listed incorporates a relatively hard asphalt having a 0 penetration value at room temperature (70 to 77° F.). In addition, the polymers listed are relatively stiff or hard polymers, with increasing styrene components resulting in increasing the hardness or stiffness of the polymers.

The TiO₂ suspension added to the protective layer in accordance with this example functions as a pigment, allowing the installer of the waterproofing coating to visually ascertain over which areas of the flexible layer the second, protective layer has been applied. Any number of known pigments can be utilized in accordance with this invention. A preferred embodiment of the pigment is the TiO₂ suspension formulation as follows:

### EXAMPLE 2

| Ingredients | Weight by % |
|---|---|
| Water | 36.4 |
| Tamol 731 dispersing agent | 0.48 |
| TiO₂ powder | 62.0 |
| 30% Ammonium hydroxide | 0.67 |
| ASE-95 Viscosity modifier | 0.39 |

In accordance with the method of the present invention, a first formulation is prepared to provide a coating comprising a flexible layer adapted to have relatively high flexibility and good low temperature flexibility, good elongation properties, and good adhesiveness. A second formulation is prepared to provide a coating comprising a hard, protective layer adapted to have relatively high tensile strength and tensile modulus and low adhesion properties. The first, flexible coating formulation is applied as a liquid. The application is preferably by spraying, painting, mopping, troweling, or other means. When applying the layer by spraying, conventional spraying equipment is used to spray the formulation onto a foundation or other surface to be treated. Although the layers can be as thick as desired for a particular application, which may also be dependent upon the particular formulation utilized, this layer is preferably sprayed to a thickness of 20-100 mils around the entire foundation or other surface. The second, protective coating formulation is then applied as a liquid by spraying, painting, mopping, troweling or by other means. When spraying, either the same or different spraying equipment can be used to spray the formulation onto the surface to be treated over the first coating layer. Again, although the layers can be as thick as desired for a particular application and based on a particular formulation, this layer is preferably sprayed to a thickness of 20-100 mils around the entire foundation or other surface. The coatings are then allowed to dry. The flexible first layer preferably comprises between 50% and 95% of the total waterproofing coating thickness, and the protective second layer preferably comprises between 10% and 50% of the total waterproofing coating.

Samples of the first, flexible layer prepared in accordance with the formulation as set forth in Example 1 and the method set forth above, were tested for the elongation and tensile strength properties of the resulting coating layers. The results of these tests were as follows:

TABLE I
Flexible coating

| | Width | Thickness | Max. force | Elongation | Tensile |
|---|---|---|---|---|---|
| Sample | (in) | (in) | (lbs) | % | Strength (psi) |
| 1 | 0.25 | 0.033 | 0.90 | 2760 | 109.1 |
| 2 | 0.25 | 0.040 | 1.08 | >2815 | 108 |
| 3 | 0.25 | 0.040 | .83 | >2815 | 83.0 |
| 4 | 0.25 | 0.039 | 0.86 | >2815 | 88.2 |
| 5 | 0.25 | 0.037 | 0.93 | 2280 | 100.5 |
| 6 | 0.25 | 0.039 | 1.04 | 2450 | 106.7 |

Samples of the second, protective layer prepared in accordance with the formulation as set forth in Example 1 and the method set forth above, were tested for the elongation and tensile strength properties of the resulting coating layers. The results of these tests were as follows:

TABLE II
Protective Coating

| | Width | Thickness | Max. force | Elongation | Tensile |
|---|---|---|---|---|---|
| Sample | (in) | (in) | (lbs) | % | Strength (psi) |
| 1 | 0.25 | 0.039 | 3.47 | 80 | 356 |
| 2 | 0.25 | 0.038 | 3.51 | 8 | 369 |

As discussed above, there are numerous formulation systems which can be incorporated into this invention in addition to the polymer asphalt system of the above examples. Accordingly, the following are examples of specific polyurethane based formulation systems of the flexible first layer in accordance with the present invention, with testing results for tensile strength, elongation, tensile modulus and Shore A hardness being provided:

### EXAMPLE 3

| | |
|---|---|
| Ingredients | Amounts |

| | | |
|---|---|---|
| Low M.W. Butadiene polymer (liquid) | 100.00 | g |
| Aromatic reinforcing polyol | 17.15 | g |
| Diundecyl phthalate (DUP) | 56.00 | g |
| Cyanox 2246 | 0.50 | g |
| Substituted hydroxyphenyl benzotrizole | 0.25 | g |
| (UV absorber) | | |
| Anti-foaming agent | 0.01 | g |
| Dibutyltin dilaurate catalyst | 1 | drop |
| Liquid diphenyl methane diisocyanate (MDI) | 37.20 | g |
| Physical Properties | | |
| Tensile strength (psi) | 634 | |
| Elongation (%) | 331 | |
| Modulus | | |
| 100% (psi) | 181 | |
| 200% (psi) | 337 | |
| 300% (psi) | 535 | |
| Hardness (Shore A) | 50 | |

### EXAMPLE 4

| Ingredients | Amounts |
|---|---|
| Low M.W. Butadiene polymer (liquid) | 100.00 g |
| Aromatic reinforcing polyol | 17.57 g |
| Burgess KE Clay (kaolin clay) | 80.00 g |
| Diundecyl phthalate (DUP) | 80.00 g |
| Cyanox 2246 | 0.50 g |
| Substituted hydroxyphenyl benzotriazole | 0.25 g |
| (UV absorber) | |
| Anti-foaming agent | 0.01 g |
| Liquid diphenyl methane diisocyanate (MDI) | 38.10 g |
| Physical Properties | |
| Tensile strength (psi) | 923 |
| Elongation (%) | 301 |
| Modulus | |
| 100% (psi) | 495 |
| 200% (psi) | 730 |
| 300% (psi) | 790 |
| Hardness (Shore A) | 57 |

### EXAMPLE 5

| Ingredients | Amounts |
|---|---|
| Low M.W. Butadiene polymer (liquid) | 100.00 g |
| Aromatic reinforcing polyol | 17.57 g |
| Calcium carbonate | 80.00 g |
| Diundecyl phthalate (DUP) | 80.00 g |
| Cyanox 2246 | 0.50 g |
| Substituted hydroxyphenyl benzotriazole | 0.25 g |
| (UV absorber) | |
| Anti-foaming agent | 0.01 g |
| Liquid diphenyl methane diisocyanate (MDI) | 38.10 g |
| Physical Properties | |
| Tensile strength (psi) | 375 |
| Elongation (%) | 252 |
| Modulus | |
| 100% (psi) | 201 |
| 200% (psi) | 324 |
| Hardness (Shore A) | 51 |

### EXAMPLE 6

| Ingredients | Amounts |
|---|---|
| Low M.W. Butadiene polymer (liquid) | 100.00 g |
| Aromatic reinforcing polyol | 17.57 g |
| Cyanox 2246 | 0.50 g |
| Substituted hydroxyphenyl benzotriazole | 0.25 g |
| (UV absorber) | |
| Anti-foaming agent | 0.01 g |
| Dibutyltin dilaurate catalyst | 0.10 g |
| Calcium octoate | 0.60 g |
| Isophorone diisocyanate | 29.41 g |
| Physical Properties | |
| Tensile strength (psi) | 980 |
| Elongation (%) | 725 |
| Modulus | |
| 100% (psi) | 238 |
| 200% (psi) | 320 |
| 300% (psi) | 410 |
| 400% (psi) | 486 |
| Hardness (Shore A) | 65 |

### EXAMPLE 7

| Ingredients | Amounts |
|---|---|
| Low M.W. Butadiene polymer (liquid) | 100.00 g |
| Asphalt | 200.00 g |
| Cyanox 2246 | 0.50 g |
| Substituted hydroxyphenyl benzotriazole | 0.25 g |
| (UV absorber) | |
| Anti-foaming agent | 0.01 g |
| Liquid diphenyl methane diisocyanate (MDI) | 12.70 g |
| Physical Properties | |
| Tensile strength (psi) | 205 |
| Elongation (%) | 470 |
| Modulus | |
| 100% (psi) | 74 |
| 200% (psi) | 92 |
| 300% (psi) | 116 |
| 400% (psi) | 139 |
| Hardness (Shore A) | 36 |

### EXAMPLE 8

| | |
|---|---|
| Ingredients | Amounts |

| | | |
|---|---|---|
| Low M.W. Butadiene polymer (liquid) | 100.00 | g |
| Aromatic reinforcing polyol | 8.78 | g |
| Asphalt | 72.90 | g |
| Naphthenic oil | 72.90 | g |
| Cyanox 2246 | 0.50 | g |
| Substituted hydroxyphenyl benzotriazole | 0.25 | g |
| (UV absorber) | | |
| Carbon black | 2.00 | g |
| Dibutyltin dilaurate catalyst | 1 | drop |
| Liquid diphenyl methane diisocyanate (MDI) | 25.40 | g |
| Physical Properties | | |
| Tensile strength (psi) | 339 | |
| Elongation (%) | 313 | |
| Modulus | | |
| 100% (psi) | 106 | |
| 200% (psi) | 192 | |
| 300% (psi) | 301 | |
| Hardness (Shore A) | 33 | |

The following are examples of specific polyurethane based formulation systems of the protective second layer in accordance with the present invention, with testing results for tensile strength, elongation, tensile modulus and Shore A hardness being provided:

### EXAMPLE 9

| | |
|---|---|
| Ingredients | Amounts |

| | | |
|---|---|---|
| Low M.W. Butadiene polymer (liquid) | 100.00 | g |
| Aromatic reinforcing polyol | 17.15 | g |
| Cyanox 2246 | 0.50 | g |
| Substituted hydroxyphenyl benzotriazole | 0.25 | g |
| (UV absorber) | | |
| Anti-foaming agent | 0.01 | g |
| Dibutyltin dilaurate catalyst | 1 | drop |
| Liquid diphenyl methane diisocyanate (MDI) | 37.20 | g |
| Physical Properties | | |
| Tensile strength (psi) | 1691 | |
| Elongation (%) | 283 | |
| Modulus | | |
| 100% (psi) | 830 | |
| 200% (psi) | 1294 | |
| Hardness (Shore A) | 84 | |

### EXAMPLE 10

| | |
|---|---|
| Ingredients | Amounts |

| | | |
|---|---|---|
| Low M.W. Butadiene polymer (liquid) | 100.00 | g |
| Aromatic reinforcing polyol | 17.57 | g |
| Burgess KE Clay (kaolin clay) | 80.00 | g |
| Cyanox 2246 | 0.50 | g |
| Substituted hydroxyphenyl benzotriazole | 0.25 | g |
| (UV absorber) | | |
| Anti-foaming Agent | 0.01 | g |
| Liquid diphenyl methane diisocyanate (MDI) | 38.10 | g |
| Physical Properties | | |
| Tensile strength (psi) | 1745 | |
| Elongation (%) | 132 | |
| Modulus 100% (psi) | 1653 | |
| Hardness (Shore A) | 87 | |

### EXAMPLE 11

| | |
|---|---|
| Ingredients | Amounts |

| | | |
|---|---|---|
| Low M.W. Butadiene polymer (liquid) | 100.00 | g |
| Aromatic reinforcing polyol | 17.57 | g |
| Calcium carbonate | 80.00 | g |
| Cyanox 2246 | 0.50 | g |
| Substituted hydroxyphenyl benzotriazole | 0.25 | g |
| (UV absorber) | | |
| Anti-foaming agent | 0.01 | g |
| Liquid diphenyl methane diisocyanate (MDI) | 38.10 | g |
| Physical Properties | | |
| Tensile strength (psi) | 1226 | |
| Elongation (%) | 240 | |
| Modulus | | |
| 100% (psi) | 794 | |
| 200% (psi) | 1076 | |
| Hardness (Shore A) | 87 | |

### EXAMPLE 12

| | |
|---|---|
| Ingredients | Amounts |

| | | |
|---|---|---|
| Low M.W. Butadiene polymer (liquid) | 100.00 | g |
| 2-Ethyl-1,3-hexanediol | 12.28 | g |
| Cyanox 2246 | 0.50 | g |
| Substituted hydroxyphenyl benzotriazole | 0.25 | g |
| (UV absorber) | | |
| Anti-foaming agent | 0.01 | g |
| Dibutyltin dilaurate catalyst | 1 | drop |
| Liquid diphenyl methane diisocyanate (MDI) | 38.10 | g |
| Physical Properties | | |
| Tensile strength (psi) | 1401 | |
| Elongation (%) | 215 | |
| Modulus | | |
| 100% (psi) | 852 | |
| 200% (psi) | 1330 | |
| Hardness (Shore A) | 82 | |

### EXAMPLE 13

| | |
|---|---|
| Ingredients | Amounts |

| | | |
|---|---|---|
| Low M.W. Butadiene polymer (liquid) | 100.00 | g |
| Aromatic reinforcing polyol | 17.57 | g |
| Cyanox 2246 | 0.50 | g |
| Substituted hydroxyphenyl benzotriazole | 0.25 | g |
| (UV absorber) | | |
| Anti-foaming agent | 0.01 | g |
| Dibutyltin dilaurate catalyst | 1 | drop |
| Liquid polymethylene diphenyl diisocyanate | 33.79 | g |
| Physical Properties | | |
| Tensile strength (psi) | 1255 | |
| Elongation (%) | 118 | |
| Modulus 100% (psi) | 1049 | |
| Hardness (Shore A) | 83 | |

It is understood that the above formulations can be utilized in the forms set forth above, or alternatively can be diluted with organic solvents to assist in applications such as spraying. In some formulations, the catalysts listed may preferably be added immediately prior to application of the formulation to the surface.

In addition to the above formulation systems based on polymeric resins, epoxy resin systems can also be useful in the present invention, and can be specifically suitable for use as both the flexible layer and the protective layer. One suitable epoxy resin is epoxy novolac resin, which would require, for either layer, dissolution of the epoxy resins in a solvent and the mixing with a curing agent prior to application. One such example for each the flexible layer and the protective layer is as follows:

### EXAMPLE 14

Flexible Coating

| Ingredients | % by Weight |
|---|---|
| Part A: | |
| Polysulfide resin | 50 |
| Aliphatic amine | 5 |
| Solvent | 45 |
| Part B: | |
| Epoxy novolac resin with curing agent | 50 |
| Solvent | 50 |

Parts A and B are combined at a job site and sprayed to form an epoxy, polysulfide based flexible coating layer.

Protective Coating

| Ingredients | % by Weight |
|---|---|
| Part A: | 57.5% to 98.5% |
| Epoxy novolac resin | 40-70 |
| Solvent | 30-60 |
| Part B: | 1.5% to 43.5% |
| Curing Agent | |

Again, parts A and B are combined at a job site and sprayed to form a protective, outer coating layer.

Styrene butadiene rubbers (SBR) are also useful in accordance with this invention. These SBR rubbers can be dissolved in solvent and have hard resins added to them in order to change the properties of such rubbers from flexible coating layers to protective coating layers. An example of both a flexible and a protective layer formed from such a styrene butadiene system is as follows:

### EXAMPLE 15

| | |
|---|---|
| Ingredients | % by weight |

Flexible Coating

| | |
|---|---|
| Styrene butadiene rubber | 15-30 |
| Tackifying resin | 15-30 |
| Organic solvent | 50 |

Protective Coating

| | |
|---|---|
| Styrene butadiene rubber | 1-15 |
| Tackifying resin | 35-49 |
| Solvent | 50 |

An alternative formulation of the flexible and the protective layers in accordance with this invention comprises acrylic polymer systems, which can be prepared to achieve a wide variety of properties ranging from soft, flexible polymers to hard plastics. Thus, these latexes and combinations of these latexes can be used to prepare both the flexible first layer and the protective second layer which together comprise the waterproofing coating or membrane of the present invention. One such example of both a flexible layer and a protective layer using acrylic polymers is as follows:

### EXAMPLE 16

| | |
|---|---|
| Ingredients | % by weight |

Flexible Coating

| | | |
|---|---|---|
| Hycar 2671 acrylic polymer latex | 90 | |
| (from B F Goodrich) | | |
| Tensile strength | 395 | psi |

| | |
|---|---|
| Elongation | 1260% |

| | | |
|---|---|---|
| 100% Modulus | 70 | psi |
| Clay filler | 7 | |
| Viscosity modifier | 3 | |

Protective Coating

| | | |
|---|---|---|
| Hycar 2600x91 acrylic polymer latex | 90 | |
| (from B F Goodrich) | | |
| Tensile strength | 1850 | psi |

| | |
|---|---|
| Elongation | 330% |

| | | |
|---|---|---|
| 100% Modulus | 828 | psi |
| Clay filler | 7 | |
| Viscosity modifier | 3 | |

Another useful alternative formulation system for use as the protective outer layer is polyvinyl chloride. An example of such a protective layer is as follows:

### EXAMPLE 17

| Ingredients | % by weight |
|---|---|
| Vinyl chloride polymer | 60-74 |
| Dioctyl phthalate | 20-26 |
| Pigment | 0-5 |
| Viscosity modifier | 3 |

It is understood that each of these formulations and systems are merely exemplary, illustrating the broad range of formulations which can be employed as either the flexible, inner layer, or the protective, hard outer layer. Any combinations of these systems can be used for the two layers, and are to be selected based on the basic properties and characteristics discussed in detail above. A wide variety of other formulations are equally useful in accordance with this invention if the requisite flexibility, adhesion, hardness and strength characteristics are achieved.

In use, a first, flexible formulation, is prepared and applied to a surface to be coated, such as a concrete foundation, cement blocks, other masonry substrate or other surfaces, by spraying or other means, using conventional liquid application equipment, with the flexible liquid formulation prepared by the methods set forth above using any appropriate formulation, including any of the above formulations described above. Once this layer has been applied, the protective liquid formulation, prepared as described above, is then applied, such as by spraying or other means, over the first layer using the same, or different, application equipment. These layers are then allowed to dry. In a preferred embodiment, the flexible layer should be sprayed at a thickness of 40 mils to 80 mils, which dries to a thickness of approximately 25 to 55 mils. The protective layer of a preferred embodiment should be sprayed at a thickness of 5 mils to 30 mils, which dries to a thickness of approximately 5 mils to 30 mils. Preferably, as stated above, the thickness of the flexible inner layer should be between 50% and 95% of the total waterproofing coating thickness, with the protective, hard outer layer thus accounting for between 5% and 50% of the total waterproofing coating.

A multiple layer waterproofing coating formed in this manner has several characteristics which are highly desirable when waterproofing below-grade surfaces; namely, such a coating is flexible and has good low temperature flexibility, good crack bridging ability, good adhesion to the concrete or other surface, low adhesion on the hard, outer surface of the coating, and high tensile strength to protect the waterproofing coating from damage which may occur during backfill or the like. Further, such a waterproofing coating presents a monolithic membrane coating having no seams or other joints, and also can be applied to vertical surfaces.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

Having thus described the invention, I/we claim:

1. A multiple layered waterproofing coating, comprising:
a first layer adapted to be received on a surface to be coated, said first layer having the characteristics of relatively high elongation, high flexibility and high adhesiveness; and
a second layer adapted to be received over the first layer after the first layer is received on the surface, said second layer forming a hard exterior portion of the coating, said second layer having the characteristics of relatively high tensile strength and high tensile modulus, relatively low adhesiveness.

2. The coating as set forth in claim 1, wherein the second layer has a tensile strength of approximately 2-4 times that of the first layer.

3. The coating as set forth in claim 1, wherein the tensile strength of the first layer ranges from approximately 10 psi to 1500 psi.

4. The coating as set forth in claim 3, wherein the tensile strength of the first layer ranges from approximately 50 psi to 500 psi.

5. The coating as set forth in claim 1, wherein the tensile strength of the second layer ranges from approximately 200 psi to 12,000 psi.

6. The coating as set forth in claim 5, wherein the tensile strength of the second layer ranges from approximately 250 psi to 4000 psi.

7. The coating as set forth in claim 1, wherein the second layer has a Shore A hardness of approximately 1-50 times that of the first layer.

8. The coating as set forth in claim 7, wherein the second layer has a Shore A hardness of approximately 2-10 times that of the first layer.

9. The coating as set forth in claim 1, wherein the second layer has a Shore A hardness of greater than 40.

10. The coating as set forth in claim 1, wherein the first layer has an elongation ranging from approximately 200% to 3000%.

11. The coating as set forth in claim 1, wherein the second layer has an elongation ranging from approximately 1% to 300%.

12. The coating as set forth in claim 11, wherein the second layer has an elongation of less than 100%.

13. The coating as set forth in claim 1, wherein the first layer has a tensile modulus of approximately 10 psi to 1000 psi.

14. The coating as set forth in claim 13, wherein the first layer has a tensile modulus of approximately 10 psi to 500 psi.

15. The coating as set forth in claim 1, wherein the second layer has a tensile modulus of approximately 500 psi to 1,450,000 psi.

16. The coating as set forth in claim 15, wherein the second layer has a tensile modulus of approximately 2000 psi to 145,000 psi.

17. The coating as set forth in claim 16, wherein the second layer has a tensile modulus of approximately 4000 psi to 5000 psi.

18. The coating as set forth in claim 1, wherein the second layer has a tensile modulus approximately 10 to 25 times that of the first layer.

19. The coating as set forth in claim 1, wherein the thickness of the first layer is approximately 25 to 55 mils.

20. The coating as set forth in claim 1, wherein the thickness of the second layer is approximately 5 to 30 mils.

21. The coating as set forth in claim 1, wherein the first layer comprises approximately 50% to 95% of the total thickness of the waterproofing coating, and the second layer comprises approximately 5% to 50% of the total thickness of the waterproofing coating.

22. A method for forming a waterproofing coating on a surface, comprising:
preparing a first liquid formulation, the first formulation adapted to provide a coating layer having the characteristics of relatively high elongation, adhesiveness, and flexibility;
applying the first liquid formulation onto a surface to be coated to form a first, flexible coating layer;
preparing a second liquid formulation adapted to provide a hard coating layer having the characteristics of relatively high tensile strength and high tensile modulus, and relatively low adhesiveness;
applying the second liquid formulation over the first layer to form a second, hard coating layer; and
allowing the coating layers to dry and form a waterproofing coating.

23. The method as set forth in claim 22, wherein the application step comprises spraying the liquid formulations onto the surface.

24. The method as set forth in claim 22, wherein the application step comprises painting, mopping or troweling the liquid formulations onto the surface.

25. A multiple layered waterproofing coating comprising:
a first layer having an inner surface and an outer surface, said inner surface of the first layer adapted to adhesively engage a substrate to be coated, wherein said first layer has the characteristics of relatively high elongation, high flexibility and high adhesiveness; and
a second layer having an inner surface and an outer surface, said inner surface of the second layer adapted to engage said outer layer of the first layer, said second layer having the characteristics of relatively high tensile strength and high tensile modulus, and relatively low adhesiveness,
said outer surface of the second layer forming a hard, abrasion and puncture resistant exterior surface of the waterproofing coating.
